(19) United States
(12) Patent Application Publication
(10) Pub. No.: US 2013/0025627 A1
(43) Pub. Date: Jan. 31, 2013

(54) CLEANING DEVICE FOR DRY CLEANING IRREGULAR OBJECTS

(71) Applicant: Hans A. Müller, Bad Reichenhall (DE)

(72) Inventor: Hans A. Müller, Bad Reichenhall (DE)

(21) Appl. No.: 13/574,317

(22) PCT Filed: Oct. 29, 2010
(86) PCT No.: PCT/EP10/66546

§ 371 Date: Oct. 17, 2012

(30) Foreign Application Priority Data
Jan. 20, 2010 (DE) 10 2010 001 061.8

(51) Int. Cl. A47L 25/00; B08B 1/00

(52) U.S. Cl. 134/6; 15/104.001; 15/1.51; 15/209.1

(57) ABSTRACT

The present invention relates to a cleaning device (100) for dry cleaning, in particular dust removal, in particular of irregular objects (150) such as miniature models, drinking vessels and the like, comprising a hollow body (110) having a first opening (120) for introducing the object (200) into the hollow body, wherein the hollow body (110) is equipped on an inner face (111-114) with dry cleaning means (130).

The present invention relates to a cleaning device for dry cleaning in particular irregular objects such as miniature models, drinking vessels and the like, a cleaning system and a cleaning method.

Miniature models such as model vehicles and the like are popular collectibles that are often stored or displayed on shelves, in glass cases and the like. Over time the miniature models become dirty, particularly dusty, so that regular cleaning is required. However, as miniature models are irregular in shape and the models may also differ considerably from one another in shape, cleaning involves some attendant effort. In particular, in the case of extensive collections of several tens or even hundreds of miniature models, the work involved in cleaning is considerable. The same applies for example to objects such as drinking vessels and the like.

Various cleaning methods for cleaning miniature models are known in the prior a

Occasionally, wet or damp cleaning is carried out, but this is very time-consuming and not very gentle. Residues of cleaning agents cause the paint to fade and make tyres and small plastic parts fragile and brittle. Water residues leave spots and do not dry off satisfactorily. Drying with hot air is unsuitable for the paint, as it may lead to paint damage. Therefore, dry cleaning methods have mainly caught on.

It is known to clean miniature models with compressed air. However, on the one hand this is laborious, as the object has to be rotated and turned frequently during the cleaning so that all the sides can be cleaned adequately. On the other hand, the compressed air blows the dust off the object and spreads it around the room, where it settles again and/or pollutes the air breathed in.

In addition it is also common to dust miniature models with small paintbrushes, brushes, cotton wool and the like. However, this involves particularly great effort, as miniature models of this kind often have a great many corners, edges, crevices, etc., which can only be cleaned very laboriously. Also, depending on the cleaning device used, a greater or lesser proportion of the dust is thrown up and thereby spread around the room. Moreover, dust adhering to the cleaning device may lead to scratch marks in the paint.

It is therefore desirable to provide a handy, particularly portable cleaning device for dry cleaning, particularly dusting irregular objects such as miniature models and the like which makes cleaning easier, reduces the amount of dust thrown up or spread around by the cleaning and minimises damage, particularly to the paint.

### DISCLOSURE OF THE INVENTION

According to the invention a cleaning device is proposed for dry cleaning, particularly dusting, in particular irregular objects such as miniature models, drinking vessels and the like, a cleaning system comprising a cleaning device according to the invention, a foldable blank for providing a cleaning device according to the invention and a cleaning method having the features of the independent patent claims. Advantageous embodiments are recited in the dependent claims and the description that follows.

### ADVANTAGES OF THE INVENTION

The invention proposes a cleaning device that is easy to handle, gentle and effective, which is also of small dimensions and preferably portable. In order to clean it, the object such as a miniature model, for example, is preferably repeatedly introduced into the cleaning device and taken out again. The dry cleaning means mounted on an inner surface of a hollow part thereby clean the object. The object is surrounded on many sides, expediently on every side, by the dry cleaning means, so that cleaning is carried out on many sides or on every side by one cleaning operation. This reduces the work involved in cleaning substantially. At the same time the dirt removed is held inside the cleaning device, so that it cannot be thrown up and spread around the room. The cleaning device is also suitable for cleaning glasses, with or without a handle.

The dry cleaning means are expediently soft and elastic and shaped like a feather duster, so that they are able to clean the in particular irregular object thoroughly and get right into any apertures, crevices, corners, etc. Feather dusters, brushes, cloths and the like, for example, are suitable as the dry cleaning means.

A particularly good dry cleaning effect is obtained if the cleaning action is based on electrostatic charging. At the same time, particularly gently cleaning is possible by this means, as the dirt picked up by the cleaning means is drawn away from the object that is to be cleaned. A more intensive action can be observed if the object that is to be cleaned is surrounded on many sides or on all sides by the dry cleaning means.

Dry cleaning means that comprise microfibres have proved particularly suitable. This is a particularly hygienic solution which at the same time produces a particularly effective electrostatic charge, so that dirt or dust is effectively attracted and picked up by the dry cleaning means. Dry cleaning means of this kind are known for example as so-called dust magnets. There are different configurations available that are suitable for the invention. For example, soft microfibre bristles or microfibre cloth strips are joined together into a kind of feather duster, no as to form a dry cleaning means.

In a preferred embodiment, the hollow body is cuboid or cylindrical in configuration. A hollow body of this kind is particularly simple to manufacture and easy to handle. As the shape of model vehicles, for which the invention is particularly suitable, is also usually substantially oblong, a cuboid or cylindrical hollow body with dry cleaning means provided on the inside achieves a particularly good cleaning action. A cleaning device of this kind is also particularly suitable for cleaning vessels such as drinking glasses, tankards, etc., with or without handles. To improve the cleaning action, at least one protuberance equipped with dry cleaning means may be provided within the hollow body, that penetrates into the interior of the drinking vessel during cleaning.

The hollow body may be configured with one or two openings for the insertion and removal of the object that is to be cleaned. If the hollow body has two openings, the cleaning operation is particularly simple as the object can be inserted through one opening and taken out again through the other opening. For example, it is also possible for the at least one opening of the hollow body to be initially closed off and not opened until it is used—either for a single use or for every use.

If for example the hollow body is made of cardboard, the at least one opening may be closed off with a corresponding lid, in which case, in a preferred embodiment, the hollow body then resembles a carton or a cylinder. In the closed state, the distribution of the cleaning devices is particularly made easier, as then both the cleaning means are protected from soiling and the stability of the cleaning device is increased. The lid may either be opened before use and then closed again, or may be permanently removed before use, e.g. torn off or cut off.

In addition to a cleaning device according to the invention, which in this case is expediently formed from a foldable material, a cleaning system according to the invention comprises a rigid cleaning device housing. The cleaning device which takes in the dust is normally itself so dirty after a certain number of cleaning operations that it needs to be cleaned or replaced. The cleaning system thus comprises a cleaning device housing into which a replaceable cleaning device is or can be inserted. If the cleaning device is soiled by the repeated cleaning of objects, the cleaning device can easily be discarded and replaced by a new one. The dirt and dust that has been picked up is thus also effortlessly discarded.

Preferably, the hollow body of the cleaning device is made of a simple, particularly foldable, material. Consequently, the cleaning device may be produced particularly cheaply as a replaceable insert for the cleaning device housing. The cleaning device may in this case be formed, for example, from cardboard with cleaning means attached thereto, particularly by adhesion. The cleaning means may preferably be standard commercial microfibre cleaning means such as for example so-called dust magnets. The cleaning device housing which is made of metal and/or plastics, for example, serves to accommodate the cleaning device in order to provide stability, first of all. In addition the cleaning device housing may also help to improve the optical appearance.

The cleaning device may be prepared in particular as a foldable blank from which a cleaning device according to the invention can be produced by suitable folding. To assist with the folding the foldable blank may be scored or cut at suitable points. This provides a particularly simple method of producing the cleaning device. In a preferred embodiment the foldable blank is configured such that the cleaning device that can be made from it by folding is of a carton-type construction with a cuboid hollow body and two cover pieces that close off the ends. In another preferred embodiment the foldable blank is configured such that the cleaning device that can be produced from it by folding is tubular with a cylindrical hollow body and two cover pieces that close off the ends.

Further advantages and embodiments of the invention will become apparent from the description and from the attached drawings.

It will be understood that the features mentioned hereinbefore and the features that are yet to be described hereinafter may be used not only in the particular combination stated but also in other combinations or on their own, without departing from the scope of the present invention.

The invention is schematically represented in the drawings by means of an exemplifying embodiment and is hereinafter described in detail with reference to the drawings.

### DESCRIPTION OF THE FIGURES

FIG. 1 shows a preferred embodiment of a cleaning device according to the invention.

FIG. 2 shows a preferred embodiment of a foldable blank according to the invention.

FIG. 3 shows a preferred embodiment of a cleaning system according to the invention.

FIG. 4 shows another preferred embodiment of a cleaning device according to the invention.

FIG. 5 shows another preferred embodiment of a foldable blank according to the invention.

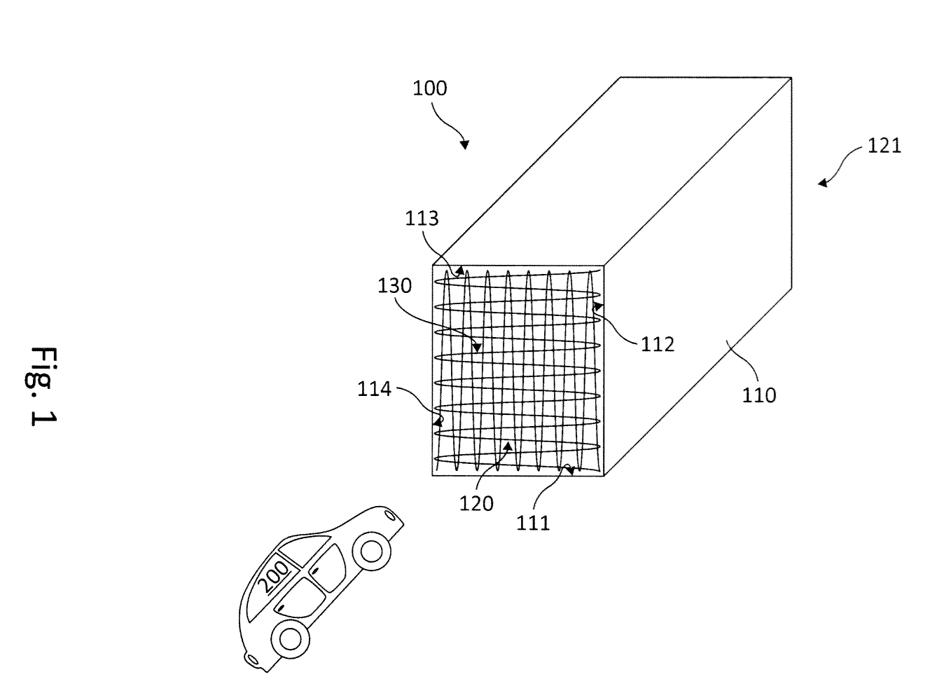

FIG. 1 shows a schematic perspective view of a preferred embodiment of a dry cleaning device according to the invention designated 100. The cleaning device 100 comprises a hollow body 110, in this case of cuboid configuration, which is preferably made of cardboard. The hollow body 110 is embodied, at its front end face, with a first opening 120 for the insertion of an object 200 that is to be cleaned, particularly a miniature model or the like. In the embodiment shown, the hollow body 110 also has a second opening 121 on the opposite side, which is not visible in this perspective view.

On each of its four inner sides 111 to 114 the hollow body 110 is equipped with dry cleaning means 130. In the present example the dry cleaning means 130 comprise microfibres and are configured so that their cleaning action is based on electrostatic charge. In particular, conventional microfibre cleaning means such as so-called dust magnets are suitable as dry cleaning means.

The first opening 120 is provided on an end face of the cuboid hollow body 110 and adjoins the four inner sides 111 to 114 that are equipped with dry cleaning means 130. The second opening 121 is opposite the first opening 120.

In order to clean an object 200, such as a miniature model, in particular, the latter is expediently inserted into the cleaning device 100 and taken out again several times. In this context it makes sense to insert the object 200 through the opening 120 into the hollow body 110 and to remove it through the opening 121. The more often this process is carried out, the better the cleaning results achieved. The cleaning process leads to electrostatic charging of the cleaning means 130, so that they are able to pick up the dust and dirt adhering to the miniature model 200 particularly effectively. Thanks to the feather duster-like shape of the cleaning means 130 these are able to adapt particularly well to irregular shapes of the objects that are to be cleaned and penetrate into all the corners, crevices, openings, etc.

Miniature models are conventionally obtainable on different scales. Scales range from 1:08 scale through 1:18, 1:43 and 1:87 to 1:160 scale. It therefore makes sense to select the dimensions of the cuboid hollow body so that they are particularly suitable for cleaning miniature models built to standard scales. For example, it is useful to provide a cleaning device adapted to miniature models built to 1:18, 1:20 and 1:24 scale. A different cleaning device may be designed to fit the 1:43 scale and yet another cleaning device may be designed to fit 1:87 scale. For example, the opening for these could range from about 120 mm to about 140 mm.

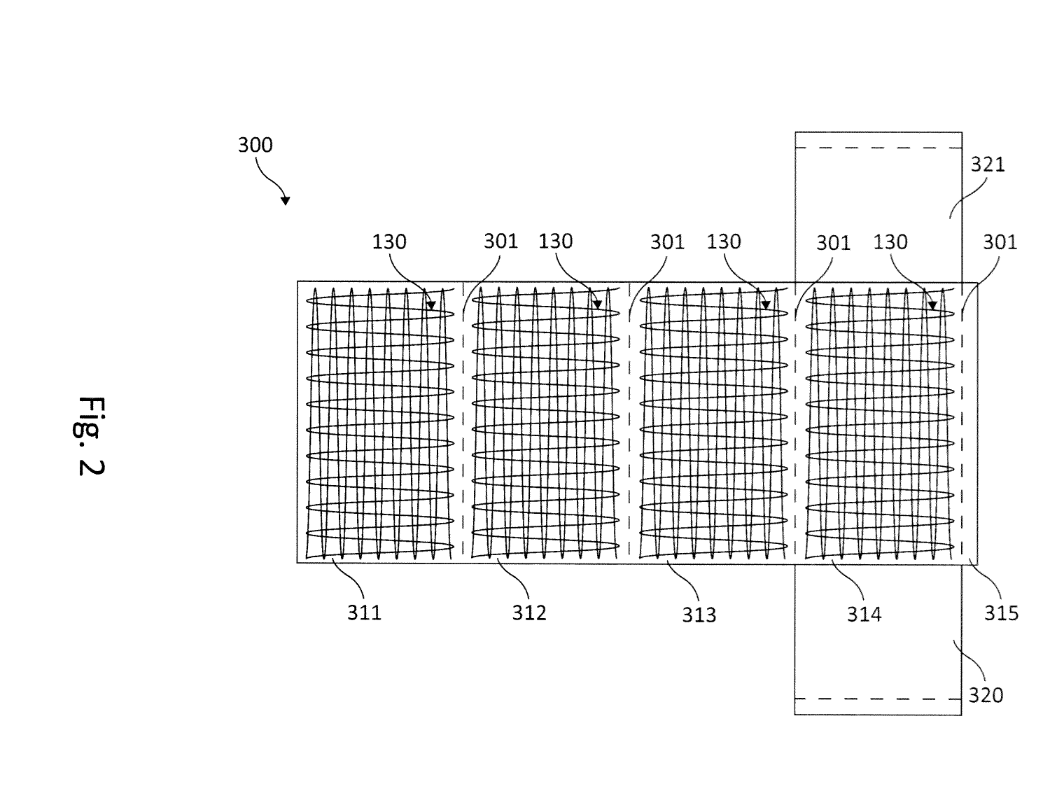

FIG. 2 shows a preferred embodiment of a foldable blank 300 according to the invention for folding to make a cleaning device, such as for example the cleaning device 100 according to FIG. 1, in schematic plan view. The elements corresponding to the elements according to FIG. 1 have been given a similar reference numeral increased by 200.

The foldable blank 300 is made of cardboard and has four fold lines 301, so that when it is folded as intended a cuboid hollow body is produced. On the foldable blank the fold lines 301 define five areas 311 to 315, of which the areas 311 to 314 are each provided with dry cleaning means 130 and after folding form the inner sides of the cuboid cleaning device produced. The region 315 serves as an adhesive region to enable the cuboid hollow body to be shaped particularly easily. The fold lines 301 may be scored to assist the folding.

In a preferred embodiment the foldable blank 300 comprises, on the base surface which is rectangular in this case, two projections 320 and 321, rectangular in this case, for forming cover pieces that close off the openings.

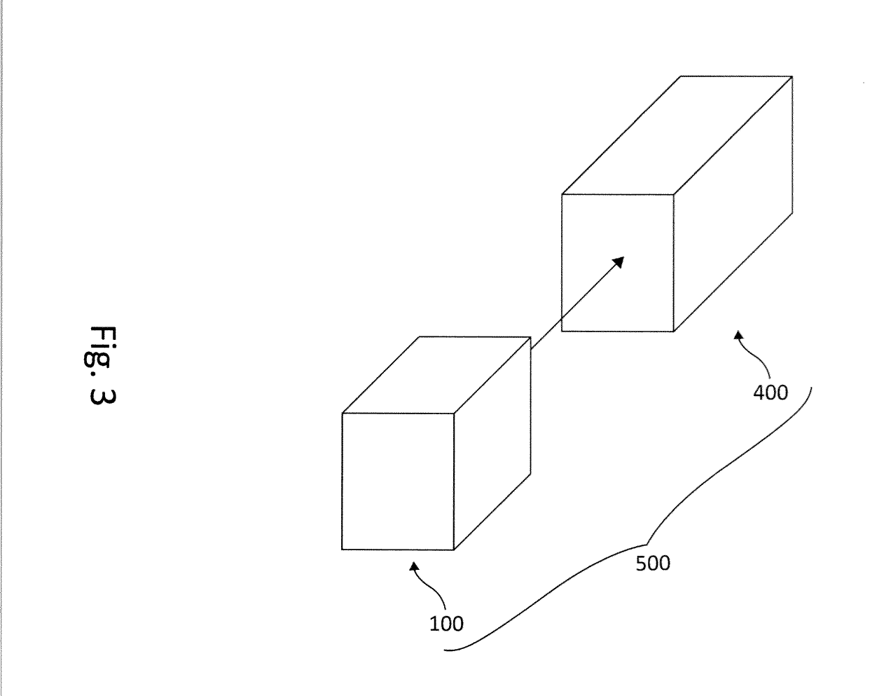

FIG. 3 shows the cleaning device 300 according to FIG. 1 together with a rigid cleaning device housing 400, which together form a preferred embodiment of a cleaning system 500 according to the invention. The cleaning device housing 400 is of such dimensions that it can accommodate and secure an associated cleaning device 100. The cleaning device housing 400 may be made of plastics and/or metal and thus provides sufficient stability for a less stable cleaning device that is made of cardboard, for example. If, in a cleaning system 500 of this kind, the cleaning device has become soiled after a certain number of cleaning operations, it can easily be changed. The stable and more valuable component of the cleaning system 500, namely the cleaning device housing 400, is retained and used again.

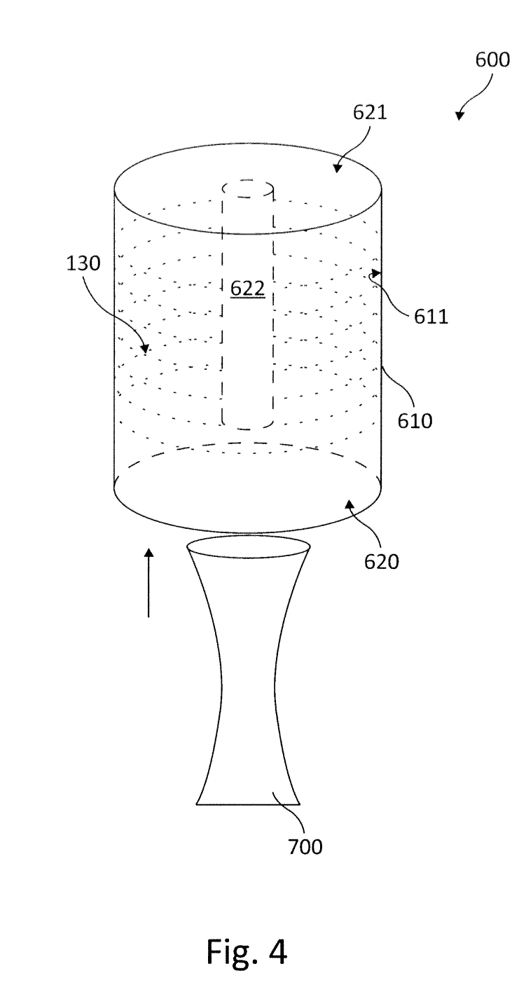

FIG. 4 schematically shows another preferred embodiment of a dry cleaning device according to the invention, which is designated 600. The cleaning device 600 here comprises a cylindrically shaped hollow body 610 which is preferably made of cardboard. The hollow body 610 is configured on its base surface with a first opening 620 for the insertion of an object 700 that is to be cleaned, particularly a drinking vessel or the like. In the example shown, the hollow body 610 has a protuberance 622 which is mounted internally on the covering surface 621 of the cylindrically shaped hollow body 610.

The inner covering surface 611 and the protrusion 622 are equipped with dry cleaning means 130. In the present example, the dry cleaning means 130 comprise microfibres and are configured such that their cleaning action is based on electrostatic charge. In particular, conventional microfibre cleaning means such as so-called dust magnets, for example, are suitable as dry cleaning means.

In order to clean an object 700, such as in particular a drinking glass, the latter is expediently introduced into the cleaning device 600 and taken out again several times. The more often this operation is carried out, the better the cleaning results obtained. In a preferred embodiment, the cleaning device 600 may be inverted over the object 700. The cleaning process causes electrostatic charging of the cleaning means 130, so that these means pick up the dust and dirt adhering to the object 700 particularly effectively. Thanks to the feather duster-like shape of the cleaning means 130 these are able to adapt particularly well to irregular shapes of the objects that are to be cleaned and penetrate into all the corners, crevices, openings, etc.

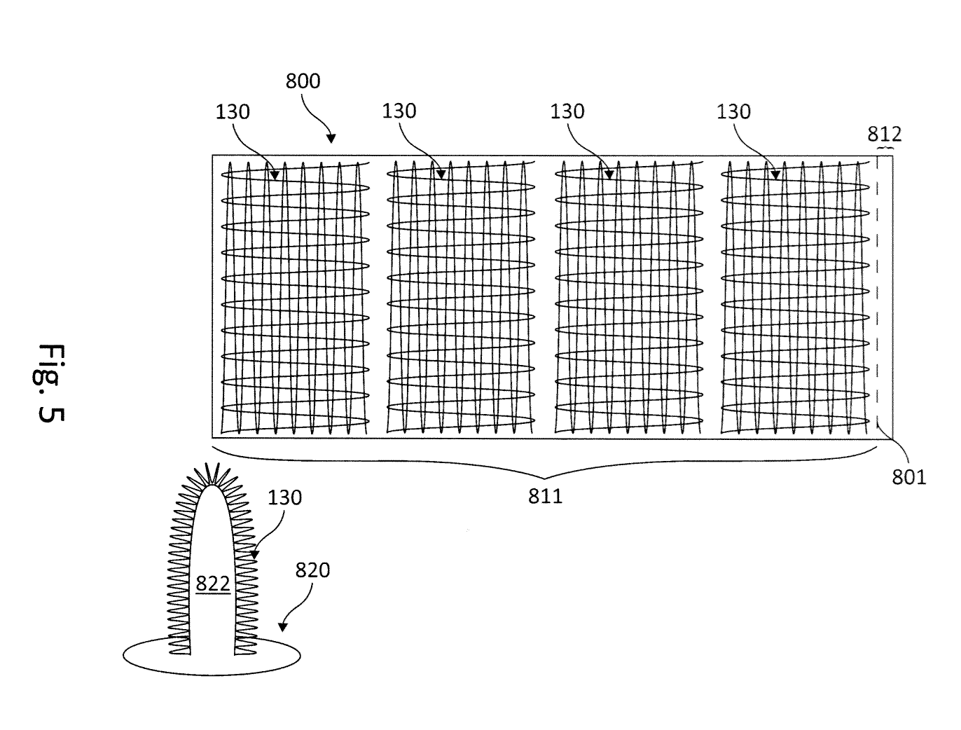

FIG. 5 shows a preferred embodiment of a foldable blank 800 according to the invention for folding into a cleaning device, such as for example the cleaning device 600 according to FIG. 4, viewed in schematic plan view. The elements corresponding to the elements according to FIG. 4 have been given a reference numeral increased by 200.

The foldable blank 800 is made of cardboard and has a fold line 801, so as to produce a cylindrical hollow body when folded in the intended manner. Two areas 811 and 812 are defined by the fold line on the foldable blank; the area 811 is provided with dry cleaning means 130 and after folding it forms the inner surface of the cylindrical cleaning device produced. The cleaning means may be provided in one or more elements.

The area 812 serves as an adhesive area in order to form the cylindrical hollow body particularly easily. The fold line 801 may be scored to assist with the folding.

In a preferred embodiment, after the folding operation the foldable blank 800 may be fitted with a circular lid 820 which carries a protuberance 822. The protuberance 822 is also provided with dry cleaning means 130.

The cleaning device 700 according to FIG. 4 may also form, together with a corresponding, rigid cleaning device housing, a preferred embodiment of a cleaning system according to the invention.

With the invention, all in all, it is possible to provide an effective but gently acting cleaning device for irregular and regular objects such as miniature models, glasses and the like, which can be produced simply and inexpensively, while providing a comparatively good cleaning action. A simple cleaning device is proposed which is nevertheless suitable for a variety of objects.

1. Cleaning device (100; 600) for dry cleaning, particularly dusting, in particular irregular objects (200; 700) such as miniature models, drinking vessels and the like, comprising a hollow body (110; 610) having a first opening (120; 620) for inserting the object (200; 700) into the hollow body, the hollow body (110; 610) being equipped on an inner side (111-114; 611) with dry cleaning means (130).

2. Cleaning device according to claim 1, wherein the dry cleaning means (130) are configured such that their cleaning action is based on electrostatic charging.

3. Cleaning device according to claim 1, wherein the dry cleaning means (130) comprise microfibres.

4. Cleaning device according to claim 1, wherein the hollow body (110; 610) is of cuboid or cylindrical configuration.

5. Cleaning device according to claim 4, wherein the cuboid hollow body (110) is equipped on three or four inner sides (111-114) with dry cleaning means (130).

6. Cleaning device according to claim 5, wherein the first opening (120) is provided on an end face of the cuboid hollow body (110), which adjoins the three or four inner sides (111-114) equipped with dry cleaning means (130).

7. Cleaning device according to claim 4, wherein the first opening (620) is provided on an end face of the cylindrical hollow body (610) and the dry cleaning means (130) are provided on the inner surface (611).

8. Cleaning device according to claim 1, wherein at least one protuberance (622; 822) equipped with dry cleaning means is provided inside the hollow body (610).

9. Cleaning device according to claim 1, wherein the hollow body (110) comprises a second opening (121) located opposite the first opening (120).

10. Cleaning device according to claim 1, wherein the hollow body (110; 610) is formed from a foldable material, particularly cardboard.

11. Cleaning system (500) comprising a cleaning device (100; 600) according to claim 1 and a rigid cleaning device housing (400), which is configured to receive and stabilise the cleaning device (100; 600).

12. Foldable blank (300; 800) for folding into a cleaning device according to claim 1.

13. Foldable blank (300; 800) according to claim 12, comprising a rectangular base surface for forming the hollow body (110; 610), the cleaning means (130) being provided on a region (311-314; 811) of the base surface that forms an inner side of the hollow body.

14. Foldable blank (300; 800) according to claim 12, comprising at least one projection (320, 321) for forming a cover piece or lid that closes off the at least one opening (120; 121).

15. Method of dry cleaning, particularly dusting, regular and irregular objects (200; 700) such as miniatures and the like, wherein the object (200; 700) is repeatedly introduced into the cleaning device (100; 600) of claim 1 and removed again.
